(19) United States
(12) Patent Application Publication
(10) Pub. No.: US 2020/0218318 A1
(43) Pub. Date: Jul. 9, 2020

(54) TEMPERATURE CONTROL APPARATUS, TEMPERATURE CONTROL METHOD, NON-TRANSITORY COMPUTER READABLE MEDIUM AND TEMPERATURE CONTROL SYSTEM

(71) Applicant: HITACHI HIGH-TECHNOLOGIES CORPORATION, Tokyo (JP)

(72) Inventors: Toru TANABE, Santa Clara, CA (US); Richard KOIKE, Rancho Mission Viejo, CA (US)

(21) Appl. No.: 16/239,729

(22) Filed: Jan. 4, 2019

(51) Int. Cl. G06F 1/20; G06F 3/0484; G05D 23/19; G06F 3/0487

(52) U.S. Cl. CPC G06F 1/206; G06F 3/0487; G05D 23/1917; G06F 3/0484

(57) ABSTRACT

It is an object to simply control an internal temperature of each individual container. A temperature control apparatus comprises a storage unit storing measurement information containing temperatures measured in a predetermined space and measurement time of the temperature; and a temperature control unit extracting a minimum temperature defined as a lowest temperature from the temperatures contained in the measurement information, stored in the storage unit, of the predetermined space, and to determine, based on the minimum temperature, a temperature zone to be kept in the predetermined space from within a plurality of temperature zones being different from each other.

### FIELD

The present invention pertains to a temperature control apparatus, a temperature control method, a non-transitory computer readable medium, and a temperature control system.

### BACKGROUND

There is growing importance of quality management of foods due to enforcement of Food Safety Modernization Act (FSMA) of U.S.A. One of items of the quality management of the foods is temperature control.

### [Patent Document 1] Japanese Patent Application Laid-Open Publication No. 2001-206452

### SUMMARY

It is requested to control about what state of temperature foods are kept in within a cooling box when putting the foods into the cooling box (container) and transporting the foods to a destination by a transport truck and other equivalent vehicles. Normally, a transporter is burdened with such an excessive load as to control internal temperatures of a multiplicity of cooling boxes to be transported. Such being the case, it is required to control the internal temperature of each cooling box without imposing the excessive load on the transporter.

When one transport truck transports a variety of foods by using a cooling box, it is requested to control temperatures of the foods according to temperature types that are different depending on the foods. The respective temperature types are previously associated with temperature zones (temperature ranges) that are to be kept. The temperature types are classified into a chilled type (Chilled, temperature zone: equal to or higher than 0° C. but lower than 10° C.), a frozen type (Frozen, temperature zone: equal to or higher than −20° C. but lower than −10° C.) and a deep frozen type (Deep Frozen, temperature zone: lower than −25° C.). A transporter (e.g., a driver of the transport truck) prepares the cooling box for every temperature type, and puts a refrigerant different per temperature type into the cooling box. There exist the refrigerants associated with the respective temperature types. The refrigerant associated with the specified temperature type is put into the cooling box, whereby an internal temperature of the cooling box is kept in the temperature zone specified by the temperature type. The transporter is required to check which temperature type the individual cooling box is managed in, but is burdened with an operation of managing the temperature types of a multiplicity of cooling boxes.

It is an object of the present invention to simply control a temperature of a predetermined space.

Means given below are adopted for solving the problems described above.

To be specific, a first aspect is a temperature control apparatus having:

a storage unit storing measurement information containing temperatures measured in a predetermined space and measurement time of the temperature; and

a temperature control unit extracting a minimum temperature defined as a lowest temperature from the temperatures contained in the measurement information, stored in the storage unit, of the predetermined space, and determining, based on the minimum temperature, a temperature zone to be kept in the predetermined space from within a plurality of temperature zones being different from each other.

The aspect of the disclosure may also be attained in such a way that an information processing apparatus runs programs. In other words, a configuration of the disclosure may be specified as a program for making the information processing apparatus execute processes to be executed the respective means in the aspect described above, or as a non-transitory computer readable recording medium recorded with the program. The configuration of the disclosure may also be specified as a method by which the information processing apparatus executes the processes to be executed by the respective means. The configuration of the disclosure may further be specified as a system including the information processing apparatus that executes the processes to be executed by the respective means.

Steps to describe the program include, as a matter of course, processes to be executed in time-series along a written sequence, and also include processes that are not necessarily executed in time-series but in parallel or individually. Apart of the steps to describe the program may be omitted.

According to the present invention, it is feasible to simply control the temperature of the predetermined space.

### BRIEF DESCRIPTION OF THE DRAWINGS

FIG. 1 is a diagram illustrating an example of a configuration of a temperature control system according to an embodiment;

FIG. 2 is a diagram illustrating an example of a configuration of function blocks of a user terminal;

FIG. 3 a view illustrating an example of a configuration of a cooling box;

FIG. 4 is a view illustrating an example of a state of opening a cover of the cooling box;

FIG. 5 is a view illustrating an example of a configuration of one surface portion of the cooling box;

FIG. 6 is a diagram illustrating an example of a configuration of function blocks of a temperature logger;

FIG. 7 is a view illustrating an example of a sectional view of the cooling box including the temperature logger;

FIG. 8 is a diagram illustrating an example of a hardware configuration of a computer;

FIG. 9 is a sequence chart illustrating an example of an operation sequence of a temperature control system according to the embodiment;

FIG. 10 is a flowchart illustrating an example of an operation flow of a user terminal;

FIG. 11 is a flowchart illustrating an example of an operation flow of the temperature logger; and

FIG. 12 is a chart illustrating an example of a graph of timewise variations of the temperature measured by the temperature logger.

### EMBODIMENTS

An embodiment will hereinafter be described with reference to the drawings. A configuration of the embodiment is an exemplification, and a configuration of the invention is not limited to a specific configuration of the embodiment of the disclosure. A specific configuration corresponding to the embodiment may be properly adopted on the occasion of carrying out the invention.

### EMBODIMENT

### Example of Configuration

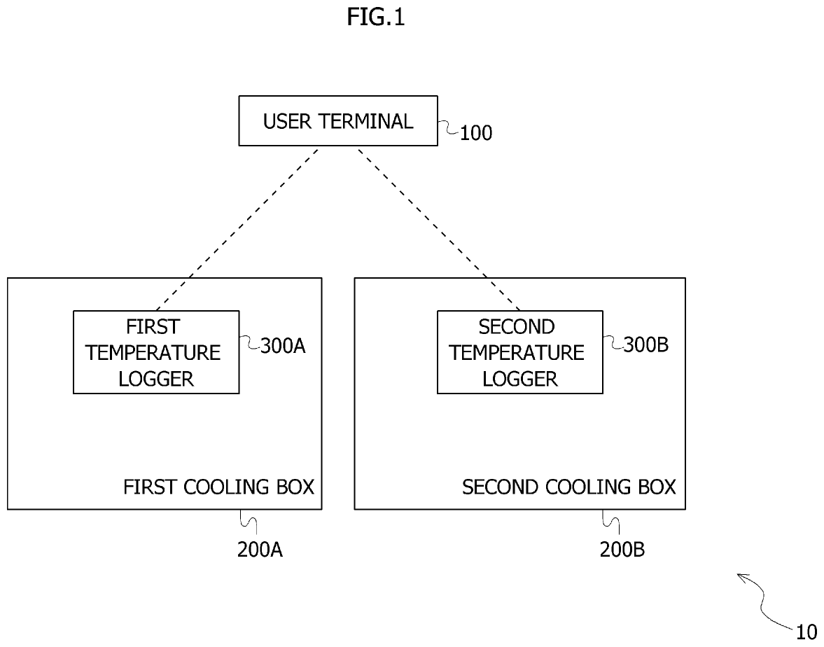

FIG. 1 is a diagram illustrating an example of a configuration of a temperature control system according to the embodiment. A temperature control system 10 in FIG. 1 includes a user terminal 100, a first cooling box 200A, a second cooling box 200B, a first temperature logger 300A, and a second temperature logger 300B. The first temperature logger 300A is installed inside the first cooling box 200A. The second temperature logger 300B is installed inside the second cooling box 200B. The first cooling box 200A and the second cooling box 200B have the same configuration. The respective cooling boxes may be, when not distinguished therebetween, simply referred to as the cooling boxes 200. The first temperature logger 300A and the second temperature logger 300B have the same configuration. The first temperature logger 300A and the second temperature logger 300B may be, when not distinguished therebetween, simply referred to as the temperature loggers 300. The cooling boxes 200 and the temperature loggers 300 may also be generically termed the cooling boxes. The user terminal 100 may also be connected to other information processing apparatuses instanced by servers via a network and other equivalent intermediaries. Herein, the 2 sets of the cooling box 200 and the temperature logger 300 are provided, and numbers of the cooling boxes 200 and the temperature loggers 300 may not, however, be limited to these numerical values. The cooling box 200 has inside a containing space for containing foods and other equivalent items. The cooling box 200 is one example of a “container”. The temperature logger 300 is one example of a “recording device”. The user terminal 100 is one example of a “temperature control apparatus”.

The cooling box 200 is capable of containing the foods and other equivalent items required to be controlled in temperature inside. The cooling box 200 containing the foods and other equivalent items is transported by being loaded into a container of a transport truck. The temperature logger 300 measures and records an internal temperature of the cooling box 200. The temperature logger 300 transmits data of the recorded temperature to the user terminal 100. The user terminal 100 carried by a driver to transport the cooling box acquires from the temperature logger 300 the internal temperature data, recorded by the temperature logger 300, of the cooling box, and records the acquired data. The driver stores the foods and other equivalent items in the cooling box 200, loads the cooling box 200 on the transport truck, and transports and hands over the foods and other equivalent items to a predetermined recipient by taking the foods and other equivalent items out of the cooling box 200.

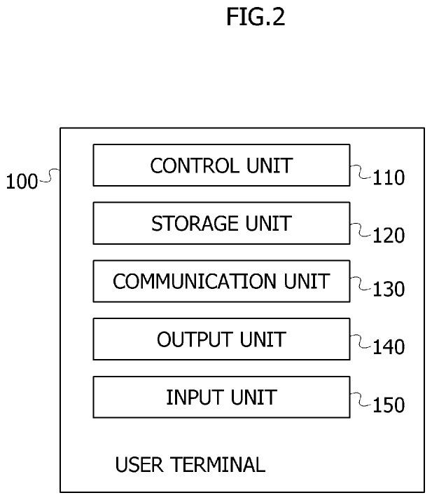

FIG. 2 is a diagram illustrating an example of a configuration of function blocks of the user terminal. The user terminal 100 includes a control unit 110, a storage unit 120, a communication unit 130, an output unit 140, and an input unit 150.

The control unit 110 acquires, from the storage unit 120, the time-based temperature data obtained from the temperature logger 300. The control unit 110 controls the user terminal 100. The control unit 110 is one example of a “temperature control unit”.

The storage unit 120 stores data, tables, programs and other equivalent pieces of software used by the user terminal 100. The storage unit 120 stores the data indicating the temperature obtained from each temperature logger 300. The storage unit 120 stores the data indicating the temperature by being associated with data of time when measuring the temperature (measurement time) and an identifier for identifying the temperature logger 300. The storage unit 120 is one example of a “terminal storage unit”.

The communication unit 130 transmits and receives (performs communications of) the data and signals to and from other devices instanced by the temperature logger 300 via the network. The communication unit 130 receives the identifier of the temperature logger 300 from the temperature logger 300. The communication unit 130 requests the temperature logger 300 to transmit measurement information containing the temperature data. Communications between the user terminal 100 and the temperature logger 300 involve using wireless communications instanced by Bluetooth (registered trademark)). The communications between the user terminal 100 and the temperature logger 300 may also involve using other communication methods. The communication unit 130 is one example of a “terminal communication unit”.

The communication unit 130 establishes a connection with a server (unillustrated) or another equivalent apparatus via the network and transmits the data of the temperature and other equivalent data acquired from the temperature logger 300 to the server, and the server may save the transmitted data.

The output unit 140 includes a display for displaying the acquired temperature data to a user of the user terminal 100.

The input unit 150 includes an input means to accept an input of an identifier for identifying the cooling box 200 and inputs of identifiers for identifying the foods and other equivalent items being put into the cooling box 200. The input means is exemplified by a keyboard, a pointing device, a touch panel and a bar code reader.

A plurality of function units among the function units of the control unit 110 and other equivalent units may also operate as one function unit.

The user terminal 100 may be attained by using a dedicated or general-purpose computer instanced by a PC (Personal Computer), a smartphone, a mobile phone, a tablet terminal, a car navigation system, a PDA (Personal Digital Assistant), a workstation (WS, Work Station), or using an electronic equipment mounted with the computer.

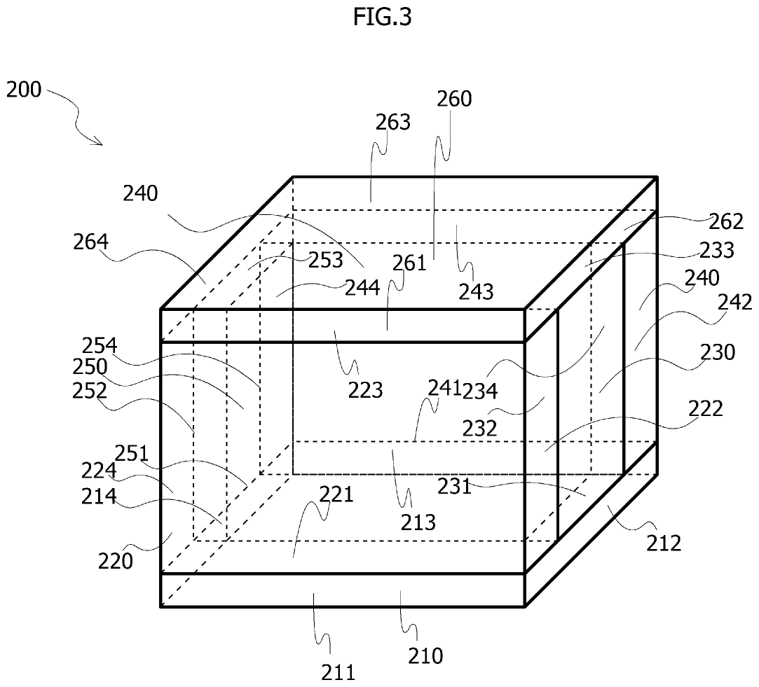

FIG. 3 is a view illustrating an example of a configuration of the cooling box. The cooling box 200 takes a rectangular parallelepiped as an external shape, and has a rectangular parallelepiped space for containing the foods and other equivalent items inside. The cooling box 200 includes a bottom surface portion 210, a front surface portion 220, a right side surface portion 230, a back surface portion 240, a left side surface portion 250, and an upper surface portion 260. Each of the bottom surface portion 210, the front surface portion 220, the right side surface portion 230, the back surface portion 240, the left side surface portion 250, and the upper surface portion 260 takes a rectangular plate shape. The bottom surface portion 210 is one example of a “bottom portion”. The bottom surface portion 210 includes a front edge portion 211, a right edge portion 212, a rear edge portion 213, and a left edge portion 214. The front edge portion 211 and the rear edge portion 213 are the edge portions having a face-to-face relationship with each other. The right edge portion 212 and the left edge portion 214 are the edge portions having the face-to-face relationship. The front surface portion 220 includes a lower edge portion 221, a right edge portion 222, an upper edge portion 223, and a left edge portion 224. The lower edge portion 221 and the upper edge portion 223 are the edge portions having the face-to-face relationship. The right edge portion 222 and the left edge portion 224 are the edge portions having the face-to-face relationship. The right side surface portion 230 includes a lower edge portion 231, a front edge portion 232, an upper edge portion 233, and a rear edge portion 234. The lower edge portion 231 and the upper edge portion 233 are the edge portions having the face-to-face relationship. The front edge portion 232 and the rear edge portion 234 are the edge portions having the face-to-face relationship. The back surface portion 240 includes a lower edge portion 241, a right edge portion 242, an upper edge portion 243, and a left edge portion 244. The lower edge portion 241 and the upper edge portion 243 are the edge portions having the face-to-face relationship. The right edge portion 242 and the left edge portion 244 are the edge portions having the face-to-face relationship. The left side surface portion 250 includes a lower edge portion 251, a front edge portion 252, an upper edge portion 253, and a rear edge portion 254. The lower edge portion 251 and the upper edge portion 253 are the edge portions having the face-to-face relationship. The front edge portion 252 and the rear edge portion 254 are the edge portions having the face-to-face relationship. The upper surface portion 260 includes a front edge portion 261, a right edge portion 262, a rear edge portion 263, and a left edge portion 264. The front edge portion 261 and the rear edge portion 263 are the edge portions having the face-to-face relationship. The right edge portion 262 and the left edge portion 264 are the edge portions having the face-to-face relationship.

Herein, the cooling box takes the rectangular parallelepiped shape, and may also take other shapes (e.g., a triangular pole shape and a cylindrical shape). It is preferable that the bottom surface portion 210 is parallel with the upper surface portion 260. The parallelism between the bottom surface portion 210 and the upper surface portion 260 enables the cooling boxes 200 to be stacked. The bottom surface portion 210 defines an external shape of the containing space.

The front surface portion 220 connects to the lower edge portion 221 of the front surface portion 220 on the side of the front edge portion 211 of an internal surface (on the side of a containing space of the cooling box 200) of the bottom surface portion 210, and stands erect from the bottom surface portion 210. The right side surface portion 230 connects to the lower edge portion 231 of the right side surface portion 230 on the side of the right edge portion 212 of the internal surface of the bottom surface portion 210, and stands erect from the bottom surface portion 210. The back surface portion 240 connects to the lower edge portion 241 of the back surface portion 240 on the side of the rear edge portion 213 of the internal surface of the bottom surface portion 210, and stands erect from the bottom surface portion 210. The left side surface portion 250 connects to the lower edge portion 251 of the left side surface portion 250 on the side of the left edge portion 214 of the internal surface of the bottom surface portion 210, and stands erect from the bottom surface portion 210. The front surface portion 220 and the back surface portion 240 have the face-to-face relationship, and the right side surface portion 230 and the left side surface portion 250 have the face-to-face relationship. The front surface portion 220 is contiguous to the upper edge portion 223 of the front surface portion 220 on the side of the front edge portion 261 of the internal surface of the upper surface portion 260. The right side surface portion 230 is contiguous to the upper edge portion 233 of the right side surface portion 230 on the side of the right edge portion 262 of the internal surface of the upper surface portion 260. The back surface portion 240 is contiguous to the upper edge portion 243 of the back surface portion 240 on the side of the rear edge portion 263 of the internal surface of the upper surface portion 260. The left side surface portion 250 is contiguous to the upper edge portion 253 of the left side surface portion 250 on the side of the left edge portion 264 of the internal surface of the upper surface portion 260. The bottom surface portion 210, the front surface portion 220, the right side surface portion 230, the back surface portion 240 and the left side surface portion 250 are one example of a “box body”. The box body configured by the bottom surface portion 210, the front surface portion 220, the right side surface portion 230, the back surface portion 240 and the left side surface portion 250 internally forms a containing space capable of containing containable contained, and has an opening portion from which to put and take the containable objects in and out of the containing space. The front surface portion 220, the right side surface portion 230, the back surface portion 240 and the left side surface portion 250 are one example of “side wall portions” of the box body. The upper surface portion 260 is one example of a “cover portion”. The upper edge portion 223 of the front surface portion 220, the upper edge portion 233 of the right side surface portion 230, the upper edge portion 243 of the back surface portion 240 and the upper edge portion 253 of the left side surface portion 250 form open edge surfaces of the opening portion of the box body. The upper surface portion 260 makes openable and closable the opening portion of the box body. The open edge surfaces of the opening portion of the box body get contact with the upper surface portion 260 on the side of the containing space in a closed state of the upper surface portion 260, but get separate from the upper surface portion 260 on the side of the containing space in an opened state of the upper surface portion 260.

The upper surface portion 260 turns about the rear edge portion 263, serving as an axis and connecting to the upper edge portion 243 of the back surface portion 240, of the surface on the side of the containing space, and functions as a cover of the cooling box 200. When the surface of the upper surface portion 260 on the side of the containing space contacts the respective upper edge portions of the opening portion, such a state occurs that the cover of the cooling box 200 is closed. When the surface of the upper surface portion 260 on the side of the containing space separates from the respective upper edge portions 223 of the opening portion, such a state occurs that the cover of the cooling box 200 is opened. The upper surface portion 260 may be separated from other portions (the box body configured by the bottom surface portion 210, the front surface portion 220, the right side surface portion 230, the back surface portion 240, and the left side surface portion 250).

An interior of the cooling box 200 is kept in the temperature zone of any one of the chilled type (Chilled, temperature zone: equal to higher than 0° C. but lower than 10° C.), the frozen type (Frozen, temperature zone: equal to or higher than −20° C. but lower than −10° C.) and the deep frozen type (Deep Frozen, temperature zone: lower than −25° C.). A predetermined refrigerant is put into the cooling box 200 in order to keep an interior of the cooling box 200 in a predetermined temperature zone. The interior of the cooling box 200 may be provided with a pocket for storing the predetermined refrigerant. The temperature types may adopt types other than those exemplified herein without being limited to the types exemplified herein.

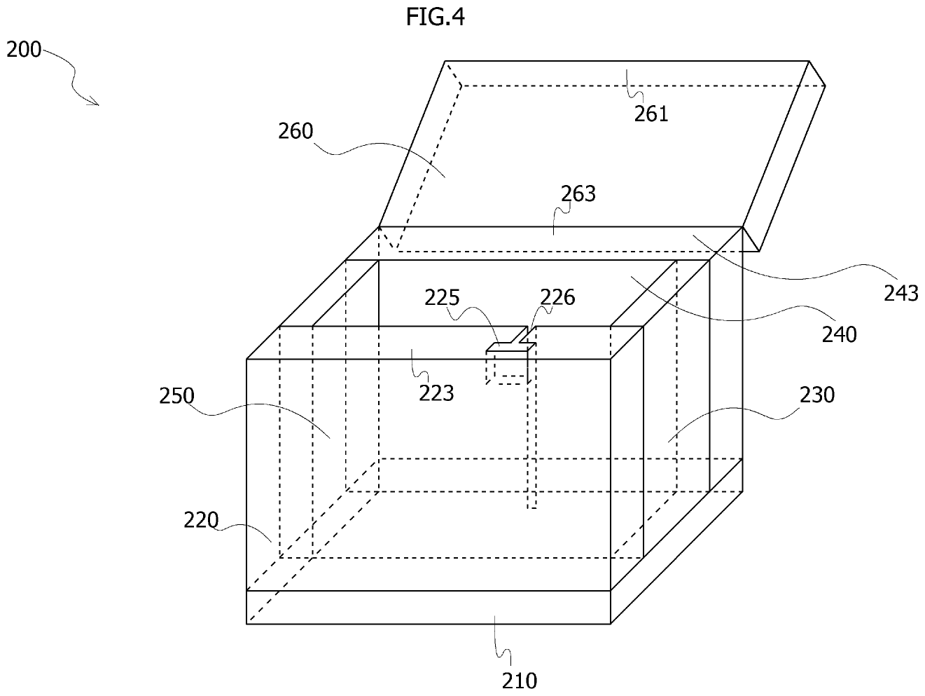

FIG. 4 is a view illustrating an example of the opened state of the cover of the cooling box. In the example of FIG. 4, the upper surface portion 260 of the cooling box 200 connects to the upper edge portion 243 of the back surface portion 240 on the side of the rear edge portion 263. The upper surface portion 260 turns about this connected portion serving as the axis, thus opening and closing the containing space of the cooling box 200. A state herein is such that the upper edge portion 223 of the front surface portion 220 gets separate from the upper surface portion 260 on the side of the containing space. The front surface portion 220 is provided with a recessed portion 225 and a groove portion 226. The recessed portion 225 formed in the upper edge portion 223 of the front surface portion 220 is a space for receiving a body unit of the temperature logger 300. The groove portion 226 configures a hole-shaped channel communicating with the containing space from the upper edge portion 223 of the front surface portion 220. The recessed portion 225 and the groove portion 226 are defined as a space for receiving the temperature logger 300. The temperature logger 300 is fixed to the recessed portion 225 and the groove portion 226. The recessed portion 225 to receive the temperature logger 300 is provided in the upper edge portion 223, thereby making it easy to take out and receive the temperature logger 300. The recessed portion 225 is one example of a “receiving recessed portion”. A portion of the groove portion 226, which is formed in the upper edge portion 223 of the front surface portion 220, is one example of an “open edge groove portion”. A portion of the groove portion 226, which is formed in a surface (internal wall surface) of the front surface portion 220 on the side of the containing space, is one example of an “internal wall groove portion”. The sensor unit 320 may be disposed not within the groove portion 226 but within the containing space in order to measure the internal temperature of the containing space.

The recessed portion 225 and the groove portion 226 are herein assumed to be provided in the front surface portion 220, and may also be provided in the right side surface portion 230, the back surface portion 240, the left side surface portion 250, or the upper surface portion 260. It may be sufficient that the recessed portion 225 and the groove portion 226 are provided in positions enabling the temperature logger 300 to communicate with devices outside the cooling box 200 when opening the cover of the cooling box 200.

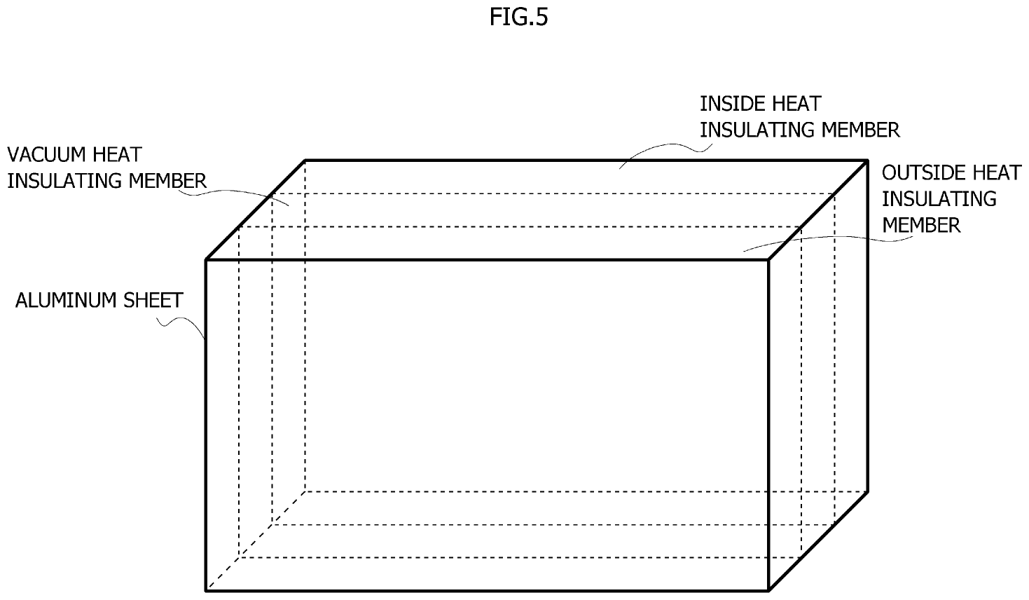

FIG. 5 is a view illustrating an example of a configuration of one surface portion of the cooling box. Each of the surface portions of the cooling box 200 takes a plate-like shape. Each of the surface portions of the cooling box 200 includes a plate-shaped inside heat insulating member, a vacuum heat insulating member, a plate-shaped outside heat insulating member, and an aluminum sheet. Other metallic sheets may also be used in place of the aluminum sheet. The aluminum sheet and the metallic sheet are one example of “metallic materials”. The vacuum heat insulating member of each surface portion is fixed by being pinched between the inside heat insulating member and the outside heat insulating member. Each surface portion including the inside heat insulating member, the vacuum heat insulating member and the outside heat insulating member is covered with the aluminum sheet on the whole. The inside heat insulating member is disposed inwardly of the cooling box 200. The outside heat insulating member is disposed outwardly of the cooling box 200. The inside heat insulating member, the vacuum heat insulating member and the outside heat insulating member are also generically termed a heat insulating member. The heat insulating member has a 3-layered structure of the inside heat insulating member, the vacuum heat insulating member and the outside heat insulating member toward the outside from the inside (containing space side) of the cooling box 200. The plate-shaped heat insulating member thermally insulates an area between one surface and the other surface. Each of the surface portions of the cooling box 200 is not limited to the plate-shaped heat insulating member having the 3-layered structure described herein, but may involve using heat insulating members having other structures. Each of the surface portions of the cooling box 200 may also be covered with the metallic sheet with respect to only the portion becoming the external surface of the cooling box 200.

The inside heat insulating member and the outside heat insulating member are, e.g., plate-shaped foamed resins instanced by foamed polystyrene and foamed urethan. Other heat insulating materials may also be used as substitutes for the foamed resin. The heat insulating member is a non-metallic member. The vacuum heat insulating member is a plate-shaped metallic member having a tightly closed space inside. The internal tightly closed space of the vacuum heat insulating member is a pre-evacuated vacuum layer. The vacuum heat insulating member includes the vacuum layer. The vacuum heat insulating member has the internal vacuum tightly-closed space, thereby thermally insulating an area between the inside heat insulating member and the outside heat insulating member. A periphery of the vacuum heat insulating member of each surface portion may be covered with the same heat insulating material as the inside heat insulating member.

The recessed portion 225 of the front surface portion 220 is provided in the outside heat insulating member of the front surface portion 220. The recessed portion 225 of the front surface portion 220 is provided on the side of the upper edge portion 223 of the front surface portion 220. The groove portion 226 is provided over the periphery of the vacuum heat insulating member of the front surface portion 220 and the inside heat insulating member in extension from the recessed portion 225. The recessed portion 225 and the groove portion 226 communicate with each other. The recessed portion 225 is provided in a position not interfering with the vacuum heat insulating member. The vacuum heat insulating member is provided in a position closer to the containing space than the recessed portion 225 on a transverse surface of the front surface portion 220.

The cooling box 200 may be configured to be folded compactly when not used.

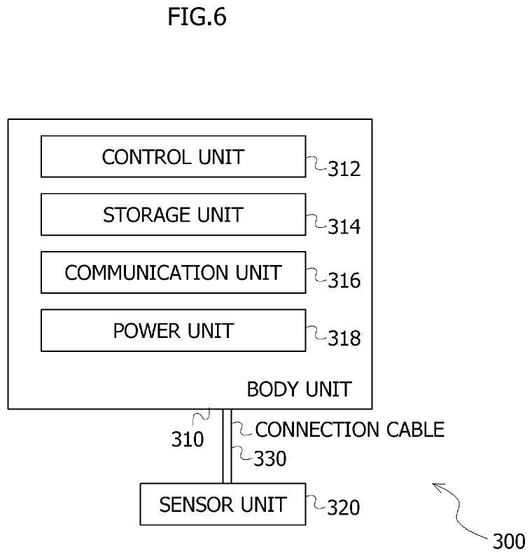

FIG. 6 is a diagram illustrating an example of a configuration of function blocks of the temperature logger. The temperature logger 300 includes a body unit 310, a sensor unit 320, and a connection cable 330 for connecting the body unit 310 to the sensor unit 320. The body unit 310 includes a control unit 312, a storage unit 314, a communication unit 316, and a power unit 318. The temperature logger 300 is installed in the recessed portion 225 and the groove portion 226 of the front surface portion 220 of the cooling box 200. The temperature logger 300 is a data logger to record a temperature measured by a temperature sensor. A logger is also called a recorder or a data recorder.

The control unit 312 acquires an ambient temperature (temperature) from the sensor unit 320. The control unit 312 stores the acquired temperature as measurement information in the storage unit 314 by being associated with time information. The control unit 312 may delete the oldest temperature data stored in the storage unit 314 when new temperature data is unable to be stored in the storage unit 314 due to an excess over a capacity of the storage unit 314.

The storage unit 314 stores the data, the tables, the programs and other equivalent pieces of software used by the temperature logger 300. The storage unit 314 stores a unique identifier for identifying the temperature logger 300. The storage unit 314 stores the temperature data measured by the sensor unit 320.

The communication unit 316 transmits and receives (performs the communications with) the data and the signals to and from the user terminal 100. The communication unit 316 transmits the identifier of the temperature logger 300 toward the user terminal 100. The communication unit 316 receives a request for transmitting the measurement information containing the temperature data from the user terminal 100. The communication unit 316 transmits the measurement information containing the temperature data to the user terminal 100. The communication unit 316 is connected to the sensor unit 320 via the connection cable 330, and receives the temperature measured by the sensor unit 320.

The power unit 318 is a power source for actuating the temperature logger 300. The power unit 318 is, e.g., a primary battery, a secondary battery and one of other equivalent batteries. The power unit 318 supplies the temperature logger 300 with electric power.

The sensor unit 320 is a temperature sensor to measure the ambient temperature at an interval of predetermined time or consecutively. The sensor unit 320 is, e.g., a thermo couple. The sensor unit 320 may also involve using other types of temperature sensors. The sensor unit 320 is connected to the body unit 310 via the connection cable 330. The connection cable 330 is one example of a “cable”.

The plurality of function units among the function units of the control unit 312 and other equivalent units may operate as one function unit.

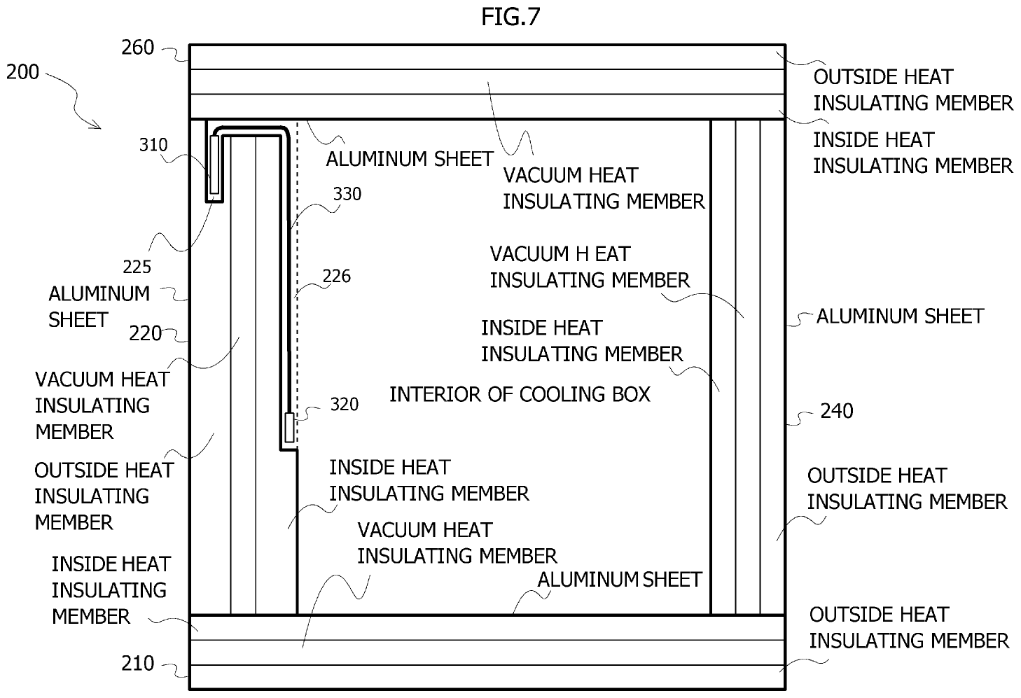

FIG. 7 is a view illustrating an example of a sectional view of the cooling box including the temperature logger. In the sectional view of FIG. 7, the front surface portion 220 and the back surface portion 240 stand erect in the face-to-face relationship at both edges of the bottom surface portion 210, and the upper surface portion 260 is placed on the front surface portion 220 and the back surface portion 240. The cooling box 200 in FIG. 7 is in a state of the cover (the upper surface portion 260) being closed. Each surface portion includes the inside heat insulating member, the vacuum heat insulating member and the outside heat insulating member. The outside heat insulating member of the front surface portion 220 is provided with the recessed portion 225, and the groove portion 226 is provided in the upper edge of the vacuum heat insulating member of the front surface portion 220 and the inside heat insulating member. The recessed portion 225 receives the body unit 310 of the temperature logger 300, and the groove portion 226 receives the sensor unit 320 of the temperature logger 300 and the connection cable 330. The sensor unit 320 faces the interior of the cooling box 200. The temperature logger 300 is attachable to and detachable from the cooling box 200.

A periphery of the cooling box 200 is covered with the aluminum sheet. In the state where the cover of the cooling box 200 is closed, the signals transmitted from the temperature logger 300 are blocked by the aluminum sheet but do not reach the devices (the user terminal 100 and other equivalent devices) outside the cooling box 200. In other words, the communications between the temperature logger 300 and the user terminal 100 are blocked. On the other hand, in the state of opening the cover of the cooling box 200, the signals transmitted from the temperature logger 300 are enabled to reach the devices (the user terminal 100 and other equivalent devices) outside the cooling box 200. In other words, there is cancelled the blocking of the communications, which is attained by the aluminum sheet covering the periphery of the cooling box 200, between the temperature logger 300 and the user terminal 100. The body unit 310 is disposed within the outside heat insulating member (outside the vacuum heat insulating member) and is thereby hard to be affected by the internal temperature of the cooling box 200. The body unit 310 includes the power unit 318, and it is therefore desirable that the temperature decreases (under, e.g., −10° C.). This is because performance of the power unit 318 decreases as the temperature becomes lower.

The temperature logger 300 may also be received in neither the recessed portion 225 nor the groove portion 226 of the front surface portion 220 but in another position of the upper surface portion 260 within the cooling box 200.

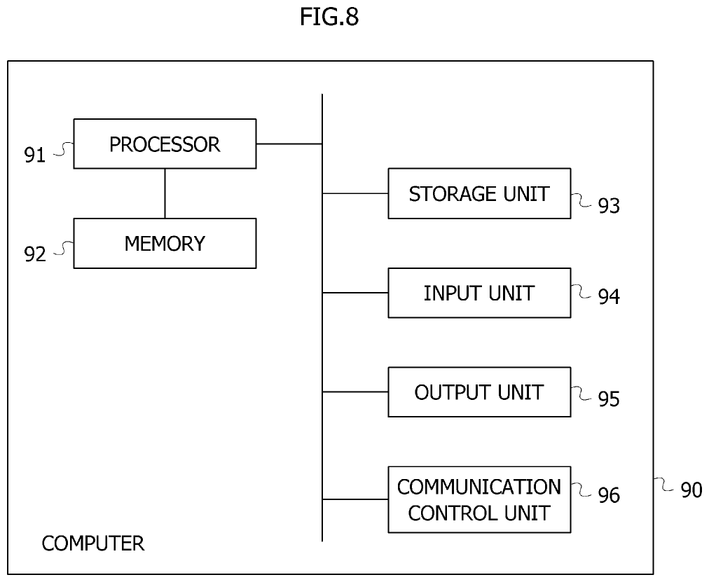

FIG. 8 is a diagram illustrating an example of a hardware configuration of a computer. The computer depicted in FIG. 8 has a configuration of a general type of computer. The user terminal 100 and the temperature logger 300 are attained by a computer 90 as illustrated in FIG. 8. The computer 90 in FIG. 8 includes a processor 91, a memory 92, a storage unit 93, an input unit 94, an output unit 95, and a communication control unit 96. The memory 92 is connected directly to the processor 91, and the components other than the memory 92 are interconnected via a bus. The storage unit 93 is a non-transitory computer readable recording medium. The hardware configuration of the computer is not limited to the example depicted in FIG. 8, but the components may be properly omitted, replaced and added.

The processor 91 loads programs, various items of data and various types of tables, which are stored on the recording medium, into a working area of the memory 92 and runs the programs, and the respective components are controlled through running the programs, whereby the computer 90 is enabled to attain functions matching with predetermined purposes.

The processor 91 is, e.g., a CPU (Central Processing Unit) or a DSP (Digital Signal Processor).

The memory 92 includes, a RAM (Random Access Memory) and a ROM (Read Only Memory). The memory 92 is also called a main storage device.

The storage unit 93 is, e.g., an EPROM (Erasable Programmable ROM) or a hard disk drive (HDD, Hard Disk Drive). The storage unit 93 may include a removable medium, i.e., a portable recording medium. The removable medium is a disc recording medium instanced by a USB (Universal Serial Bus) memory, a CD (Compact Disc), or a DVD (Digital Versatile Disc). The storage unit 93 is also called a secondary storage device.

The storage unit 93 stores the various categories of programs, the various items of data and the various types of tables in a readable/writable manner. The storage unit 93 stores an operating system (Operating System: OS), the various categories of programs and the various types of tables. Information stored in the storage unit 93 may also be stored in the memory 92. Information stored in the memory 92 may also be stored in the storage unit 93.

The OS is software operating as an intermediary between the software and the hardware, and for managing a memory space, files, processes and tasks. The OS includes a communication interface. The OS includes a communication interface. The communication interface is a program for transmitting and receiving the data to and from other external devices connected via the communication control unit 96. The external devices embrace, e.g., other computers, external storage devices and other equivalent devices.

The input unit 94 includes a keyboard, a pointing device, a wireless remote controller, a touch panel and other equivalent devices. The input unit 94 may also include a video/image input device instanced by a camera, and a voice/sound input device instanced by a microphone.

The output unit 95 includes a display device instanced by an LCD (Liquid Crystal Display), an EL (Electroluminescence) panel, a CRT (Cathode Ray Tube) display and a PDP (Plasma Display Panel), and an output device instanced by a printer. The output unit 95 may also include a voice/sound output device instanced by a loudspeaker.

The communication control unit 96 establishes connections to other apparatuses and controls communications between the computer 90 and other apparatuses. The communication control unit 96 is instanced by a LAN (Local Area Network) interface board, a wireless communication circuit for wireless communications, and a communication circuit for wired communications. The LAN interface board and the wireless communication circuit are connected to a network exemplified by the Internet.

The processor loads programs stored in an auxiliary storage device into the main storage device and runs the programs, whereby the computer to attain the user terminal 100 implements functions as the respective function units. The storage unit of the user terminal 100 is provided in a storage area of the main storage device or the auxiliary storage device.

The processor loads programs stored in the auxiliary storage device into the main storage device and runs the programs, whereby the computer to attain the temperature logger 300 implements functions as the respective function units. On the other hand, the storage unit of the temperature logger 300 is provided in a storage area of the main storage device or the auxiliary storage device.

### Operational Example

<Operation of Temperature Control System>

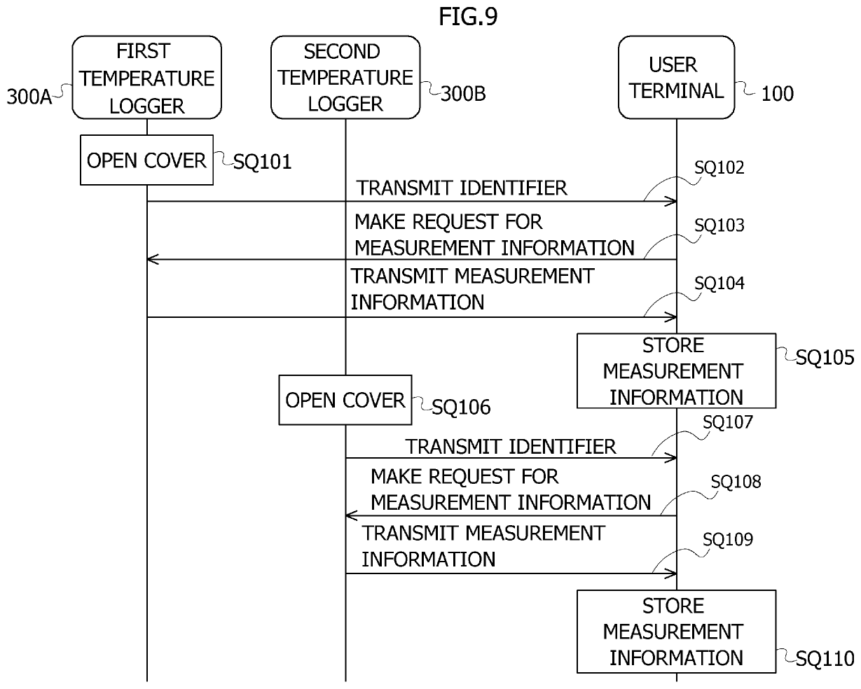

FIG. 9 is a sequence chart illustrating an example of an operation sequence of the temperature control system according to the embodiment. In a temperature control system 10, the first temperature logger 300A is installed within the first cooling box 200A, and the second temperature logger 300B is installed within the second cooling box 200B. The respective temperature loggers 300 continuously transmit the signals containing the self-identifiers. When the cover of the cooling box 200 is closed, the user terminal 100 does not receive the signal transmitted from the temperature logger 300. The user terminal 100 is carried by the user who opens and closes the cover of the cooling box 200. In the temperature logger 300, the sensor unit 320 continuously measures the internal temperature of the cooling box 200. The temperature logger 300 stores the measured temperature as the measurement information in the storage unit 314 by being associated with the time when measuring the temperature. The measurement information may contain the identifier for identifying the temperature logger 300. The discussion herein is focused on an operation between the user terminal 100 and the temperature logger 300, and operations of the respective devices will be described afterward.

In SQ101, the user opens the cover of the first cooling box 200A in which the first temperature logger 300A is installed.

In SQ102, the control unit 312 of the first temperature logger 300A transmits, toward the user terminal 100, the signal containing the self-identifier (the identifier for identifying the first temperature logger 300A) via the communication unit 316. Herein, the cover of the first cooling box 200A is opened, and hence the signal is received by the communication unit 130 of the user terminal 100. When the cover of the first cooling box 200A is not opened, the signal is not received by the communication unit 130 of the user terminal 100.

In SQ103, the control unit 110 of the user terminal 100, upon receiving the signal containing the identifier of the first temperature logger 300A via the communication unit 130, transmits to the first temperature logger 300A a signal (request signal) for requesting the transmission of the measurement information containing the temperature data and the time data through the communication unit 130. The first temperature logger 300A receives the request signal from the user terminal 100 via the communication unit 316.

In SQ104, the control unit 312 of the first temperature logger 300A, upon receiving the request signal via the communication unit 316, transmits the measurement information containing the temperature data stored in the storage unit 314 and the time data associated with the temperature data to the user terminal 100 via the communication unit 316. The control unit 110 of the user terminal 100 receives the measurement information containing the temperature data and the time data via the communication unit 130.

Operations in SQ102 through SQ104 are executable in a time well shorter than the time till closing the cover after putting in and taking out the foods and other equivalent items since the user of the user terminal 100 has opened the cover of the cooling box 200.

In SQ105, the control unit 110 of the user terminal 100 stores the received measurement information containing the temperature data and the time data together with the identifier of the first temperature logger 300A in the storage unit 120. The control unit 110 of the user terminal 100 stores, in the storage unit 120, the present time as the time when opening the cover of the cooling box 200 in which the first temperature logger 300A is installed.

The control unit 110 of the user terminal 100 may display such a prompt on the output unit 140 as to input the identifier of the first cooling box 200A with the cover being opened. The identifier of the first cooling box 200 is a unique identifier allocated beforehand to the cooling box 200. The identifier of the first cooling box 200 is previously described, e.g., in the cooling box 200. Hereat, the control unit 110 of the user terminal 100 may accept the input of the identifier of the first cooling box 200A by using the input unit 150. The control unit 110 of the user terminal 100 stores, when the identifier of the first cooling box 200A is inputted, the inputted identifier in the storage unit 120 by being associated with the identifier of the first temperature logger 300A. The temperature control system 10 is thereby enabled to control the internal temperature of the first cooling box 200A in which the first temperature logger 300A is installed. Herein, the identifier of the first cooling box 200A may be replaced by an identifier of one of the foods taken out of the first cooling box 200A (or the foods put into the first cooling box 200A) and other equivalent items. In this case, the temperature control system 10 is enabled to control temperatures of the foods having the temperatures measured by the first temperature logger 300A. The user terminal 100 starts the communications with the first temperature logger 300A upon opening the cover of the first cooling box 200A.

An operation sequence in SQ106 through SQ110 is a sequence when opening the second cooling box 200B. The operation sequence when opening the second cooling box 200B is the same as the operation sequence (SQ101 through SQ105) when opening the first cooling box 200A. The repetitive description thereof is herein omitted.

The user terminal 100 is thereby enabled to acquire the internal temperature data (a history of temperatures) of the cooling box 200 when opening the cover of this cooling box 200. The user of the user terminal 100, when opening the cover, inputs the identifier of the cooling box 200 with the cover being opened and is thereby enabled to make it easy to associate the cooling box 200 and the temperature logger 300 with each other. The user terminal 100 performs the communications with the temperature logger 300 installed in the cooling box 200 when the cover of the cooling box 200 remains opened. The user terminal 100 does not perform the communications with the temperature logger 300 installed in the cooling box 200 when the cover of the cooling box 200 remains closed.

<Operation of User Terminal>

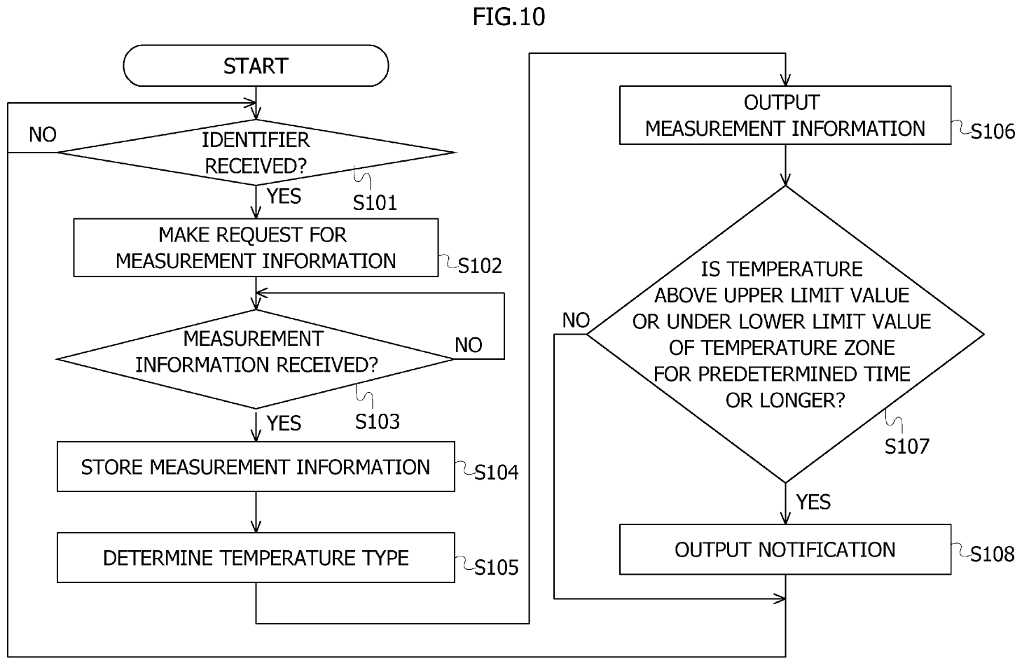

FIG. 10 is a flowchart illustrating an example of an operation flow of the user terminal. The user terminal 100 is carried by the driver (user) of the transport truck for transporting the cooling box 200 containing the foods and other equivalent items.

In S101, the control unit 110 of the user terminal 100 checks whether the communication control unit 130 receives the signal containing the identifier of the temperature logger 300. When receiving the signal (S101; YES), the processing proceeds to S102. Whereas when not receiving the signal (S101; NO), the process in S101 is iterated.

In S102, the control unit 110 of the user terminal 100, when receiving the signal containing the identifier of the temperature logger 300 via the communication control unit 130, transmits to the temperature logger 300 a signal (request signal) for requesting the transmission of the measurement information containing the temperature data via the communication control unit 130.

In S103, the control unit 110 of the user terminal 100 checks whether the communication control unit 130 receives the signal containing the temperature data from the temperature logger 300. When receiving the signal (S103; YES), the processing proceeds to S104. Whereas when not receiving the signal (S103; NO), the process in S103 is iterated.

In S104, the control unit 110 of the user terminal 100 receives the signal containing the measurement information containing the temperature data and the time data indicating the time when measuring the temperature via the communication control unit 130. The control unit 110 of the user terminal 100 stores, in the storage unit 120, the measurement information containing the temperature data and the time data together with the identifier, received in S102, of the temperature logger 300. The control unit 110 of the user terminal 100 stores, in the storage unit 120, the present time as the time when opening the cover of the cooling box 200 in which the temperature logger 300 is installed (the time when the cover is opened and closed).

The control unit 110 of the user terminal 100 may display such a prompt on the output unit 140 as to input the identifier of the cooling box 200 with the cover being opened. Hereat, the control unit 110 of the user terminal 100 may accept the input of the identifier of the cooling box 200 through the input unit 150. The control unit 110 of the user terminal 100, when the user inputs the identifier of the cooling box 200, stores the inputted identifier and the identifier of the temperature logger 300 by being associated with each other in the storage unit 120. The temperature control system 10 is thereby enabled to control the internal temperature of each cooling box 200 in which the temperature logger 300 is installed. The identifier of the cooling box 200 may be replaced by the identifier of each of the foods (or the foods put into the cooling box 200) and other equivalent items taken out of the cooling box 200 with the cover being opened.

In S105, the control unit 110 of the user terminal 100 determines the temperature type of the interior of the cooling box 200. The control unit 110 extracts the stored measurement information from the storage unit 120, and further extracts a minimum temperature defined as the lowest temperature from the temperatures of the extracted temperature data. The control unit 110 determines the temperature type as the chilled type when the extracted temperature is equal to or higher than −10° C. but lower than 10° C., as the frozen type when equal to or higher than −25° C. but lower than −10° C., and as the deep frozen type when lower than −25° C. Note that threshold values of the temperature types of the respective temperature zones may be arbitrarily set. The control unit 110 stores the determined temperature type by being associated with the measurement information in the storage unit 120. The control unit 110 may determine, based on the minimum temperature, the temperature zone serving as a substitute for the temperature type and being associated with the temperature type, and may store the determined temperature zone by being associated with the measurement information in the storage unit 120. A range of the minimum temperature of the containing space of the cooling box 200 differs depending on the temperature types (the chilled type, the frozen type and the deep frozen type). Hence, the control unit 110 detects the minimum temperature and is thereby enabled to determine the temperature type (the temperature zone) of the containing space of the cooling box 200. The temperature type (the temperature zone) and the temperature range, associated with the temperature type (the temperature zone), of the minimum temperature are associated with each other and thus stored in, e.g., the storage unit 120. Hereat, the control unit 110 determines the temperature type, based on an associated relationship between the temperature type and the temperature range of the minimum temperature, which are stored in the storage unit 120.

The refrigerant associated with each temperature type is set in a way that keeps the temperature of the containing space in the temperature zone of each temperature type for the longest possible time. The refrigerant is therefore set so that the temperature of the containing space becomes a temperature lower than the temperature of the temperature zone specified by the temperature type immediately after being put into the containing space as the case may be. Accordingly, the temperature zone on the occasion of determining the temperature type herein becomes a range wider than the temperature zone specified by the temperature type as the case may be. For example, it is required in the chilled type to keep the containing space at a temperature equal to or higher than 0° C. but lower than 10° C.; the temperature, however, becomes lower than 0° C. immediately after putting the refrigerant associated with the chilled type into the containing space as the case may be; and hence the minimum temperature on the occasion of determining the temperature type as the chilled type is set equal to or higher than −10° C. but lower than 10° C.

In S106, the control unit 110 of the user terminal 100 causes the output unit 140 to display the temperature data contained in the measurement information acquired from the temperature logger 300 together with the time data indicating the time when measuring the temperature. The control unit 110 causes the output unit 140 to further display the temperature type determined in S105. The output unit 140 displays the temperature data, the time data and the temperature type to the user of the user terminal 100 on a display and other equivalent displaying devices. The control unit 110, when not categorized in any of those temperature types in S105, causes the output unit 140 to display notification. A case of not putting the refrigerant into the cooling box 200 is considered as the case of not being categorized in any of those temperature types in S105. The output unit 140 displays, on the display and other equivalent displaying devices, the notification for notifying a purport that the temperature is abnormal (equal to or higher than the predetermined temperature) to the user of the user terminal 100. The user of the user terminal 100 is thus enabled to check the internal temperature history (the timewise variations of the temperature) of the cooling box 200 and the notification. The control unit 110 of the user terminal 100 may also cause the output unit to display the time when opening the cover of the cooling box 200.

In S107, the control unit 110 of the user terminal 100 determines whether the temperature (the internal temperature of the cooling box 200) contained in the measurement information acquired from the temperature logger 300 exceeds an upper limit value or is lower than a lower limit value of the temperature zone of the temperature type determined in S105 for a predetermined period time or longer. The predetermined period of time is settled based on a period of time for which to cause harmful effects in qualities of the foods and other equivalent items put into the cooling box 200. It is herein assumed that a determination target is a temperature measured after the time when measuring the minimum temperature extracted in S105. This is because a point before reaching the minimum temperature is considered as a point immediately after putting the refrigerant into the cooling box 200 and as a point before reaching the temperature zone of the predetermined temperature type, and the state thereof is deemed not to be abnormal. The predetermined period of time is, e.g., one hour. For example, a temperature measurement interval is 3 min, and the temperatures over the upper limit value of the temperature zone of the temperature type determined in S105 are measured 20 times consecutively, in which case the control unit 110 determines that the temperatures exceed the upper limit value of the temperature zone for one hour (=3 min×20=60 min). An event that the temperature of the containing space of the cooling box 200 exceeds the upper limit value or becomes lower than the lower limit value of the temperature zone of the temperature type determined S105 for the predetermined period of time or longer is considered to indicate abnormality of the refrigerant (a mistake in type or quantity of the refrigerant) or abnormality (damages) of the cooling box 200. When the temperature exceeds the upper limit value or becomes lower than the lower limit value of the temperature zone of the temperature type determined S105 for the predetermined period of time or longer (S107; YES), the processing proceeds to S108. Whereas when the temperature neither exceeds the upper limit value nor becomes lower than the lower limit value of the temperature zone of the temperature type determined S105 for the predetermined period of time or longer (S107; NO), the processing loops back to S101.

In S108, the control unit 110 of the user terminal 100 causes the output unit 140 to output such notification that the temperature of the containing space of the cooling box 200 exceeds the upper limit value or becomes lower than the lower limit value of the temperature zone of the temperature type determined S105 for the predetermined period of time or longer. The output unit 140 displays, on the display and other equivalent displaying devices, the notification (image, text and other equivalent pieces of information) indicating that the temperature is beyond the range of the temperature zone for the predetermined period of time or longer to the user of the user terminal 100. The output unit 140 may also display the notification and an alarm together with the measurement information displayed in S106. Thereafter, the processing loops back to S101.

The user checks the temperature history, the notification and the alarm and is thereby enabled to assure, e.g., qualities of the foods and other equivalent items put into the cooling box 200 and to determine a stop of delivery of the foods and other equivalent items. The control unit 110 may transmit the temperature data and other equivalent data to other information processing apparatuses instanced by the servers via the communication control unit 130.

<Operation of Temperature Logger>

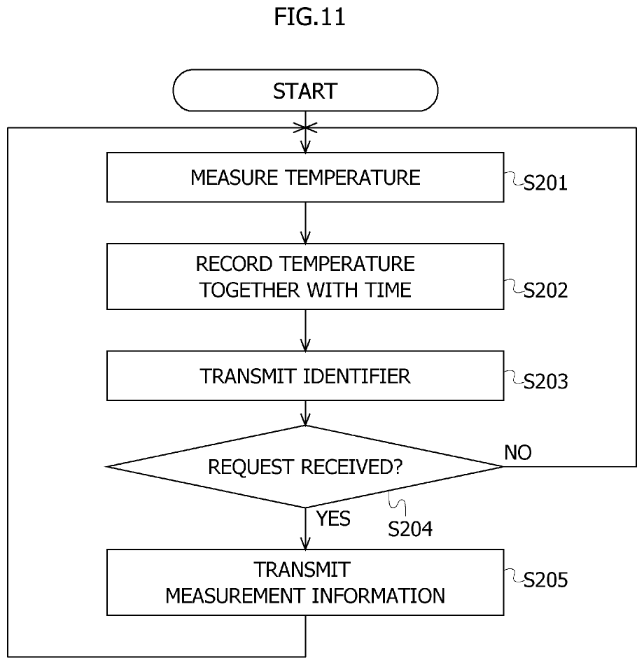

FIG. 11 is a flowchart illustrating an example of an operation flow of the temperature logger. The temperature logger 300 is installed in the interior of the cooling box 200. It is assumed in principle that the refrigerant associated with any one of the temperature types is put in the containing space of the cooling box 200.

In S201, the control unit 312 of the temperature logger 300 measures the ambient temperature by use of the sensor unit 320. The temperature may also be measured at an interval of predetermined time (e.g., at every one minute).

In S202, the control unit 312 of the temperature logger 300 stores the measured temperature together with the time (present time) when measuring the temperature in the storage unit 314.

In S203, the control unit 312 of the temperature logger 300 transmits the signal containing the self-identifier (the identifier for identifying the temperature logger 300) to the user terminal 100 via the communication control unit 316. This signal is not received by the user terminal 100 when the cover of the cooling box 200 remains closed.

In S204, the control unit 312 of the temperature logger 300 checks whether the communication control unit 316 receives the signal (request signal) for requesting the transmission of the measurement information containing the temperature data from the user terminal 100. When receiving the signal (S204; YES), the processing proceeds to S205. Whereas when not receiving the signal (S204; NO), the processing loops back to S201.

In S205, the control unit 312 of the temperature logger 300 transmits the measurement information containing the temperature data stored in the storage unit 314 and the time data associated with the temperature data to the user terminal 100 via the communication control unit 316. Thereafter, the processing loops back to S201.

The temperature logger 300 is thereby enabled to measure the internal temperature of the cooling box 200 and to transmit the temperature data and other equivalent data to the user terminal 100 when opening the cover of the cooling box 200.

The temperature logger 300 may transmit the measurement information containing the temperature data indicating the measured temperature while continuously measuring the internal temperature of the cooling box 200. The measurement information is transmitted to the outside when opening the cover of the cooling box 200. Hereat, the user terminal 100 may receive the measurement information from the temperature logger 300 without transmitting the request signal for requesting the transmission of the measurement information. The user terminal 100 is able to acquire the measurement information (the temperature history) of the cooling box 200 with the cover being opened by the user. Hereat, it is apparent that the measurement information received by the user terminal 100 is the measurement information of the cooling box 200 with the cover being opened by the user, and hence the temperature logger 300 may not transmit the identifier for identifying the temperature logger 300.

### Measurement Example

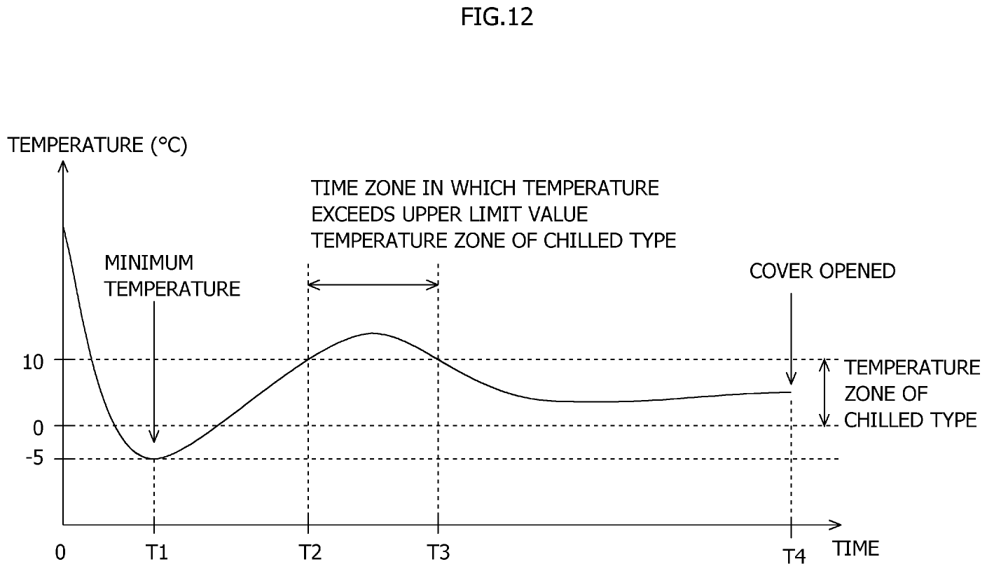

FIG. 12 is a chart illustrating an example of a graph of the timewise variations of the temperature measured by the temperature logger. An axis of abscissa of the graph in FIG. 12 indicates time, and an axis of ordinate indicates the temperature (° C.). The graph in FIG. 12 is one example of the temperature data and the time data displayed by the output unit 140 in S106. The temperature logger 300 is to be installed within the cooling box 200. The temperature measured by the temperature logger 300 is the temperature of the containing space of the cooling box 200. The temperature variations in FIG. 12 are given as one example, and the temperature of the containing space of the cooling box 200 does not necessarily vary as in FIG. 12. The predetermined refrigerant is to be put into the cooling box 200 at the time “0”. The power source of the temperature logger 300 is switched ON at the time “0”, or the temperature logger 300 is reset at the time “0”, whereby the temperature logger 300 starts measuring the temperature of the containing space of the cooling box 200. It is herein assumed that the refrigerant associated with the chilled type (equal to or higher than 0° C. but lower than 10° C.) is put into the cooling box 200.

In FIG. 12, the cooling box 200 is not cooled for a short while since the time “0”, and the temperature of the containing space of the cooling box 200 is therefore higher than the temperature zone (equal to or higher than 0° C. but lower than 10° C.) of the chilled type. When the interior of the cooling box 200 is cooled by the refrigerant, the temperature of the containing space of the cooling box 200 decreases stepwise. At the time “T1”, the temperature of the containing space of the cooling box 200 reaches the minimum temperature. Thereafter, the temperature of the containing space of the cooling box 200 rises stepwise. When becoming the time “T2”, the temperature of the containing space exceeds the upper limit value of temperature zone of the chilled type, and this state continues till the time “T3”. When a period of time (T3−T2) for which the temperature exceeds the upper limit value of the temperature zone of the chilled type is equal to or longer than the predetermined period of time in S107 (S107; YES), the notification is outputted in S108. The cover of the cooling box 200 is opened at the time “T4”. When opening the cover of the cooling box 200, the communications are performed between the user terminal 100 and the temperature logger 300, and the user terminal 100 receives the measurement information. Thereafter, the user terminal 100 outputs the measurement information and outputs the notification, based on the predetermined conditions (S107 and other equivalent steps). FIG. 12 illustrates the example in which the temperature type is the chilled type, and the same operation is, however, applied to other temperature types. The values of the temperature types of the respective temperature zones are set arbitrarily as the case may be.

### Operation and Effect of Embodiment

The temperature control system 10 controls the internal temperature of the cooling box 200 into which the foods and other equivalent items are put. The temperature logger 300 measures the internal temperature of the cooling box 200. The internal temperature of the cooling box 200 may be deemed to be a temperature of the foods and other equivalent items as a whole. When the user of the user terminal 100 takes the foods and other equivalent items out of the cooling box 200, the user terminal 100 acquires the temperature data from the temperature logger 300. The user terminal 100 outputs the acquired temperature data, the temperature types and other equivalent items, thereby enabling the user to check the temperature history of the foods, the temperature types and other equivalent items. The cooling box 200 into which the foods and other equivalent items are put may be transported by the transport truck and other equivalent vehicles. Hereat, for example, the user (the driver of the transport truck) of the user terminal 100 is enabled to check the temperature history of the foods and other equivalent items during the transportation at a recipient place of the foods and other equivalent items. The user of the user terminal 100 is also enabled to check the temperature type of the cooling box 200 during the transportation at the recipient place of the foods and other equivalent items. The notification is outputted when the abnormality occurs in the cooling box 200, the user of the user terminal 100 is thereby enabled to recognize the abnormality.

The temperature logger 300 is disposed within the cooling box 200, and measures the temperature of the containing space of the cooling box 200. The temperature logger 300 is enabled to perform the communications with the devices outside the cooling box 200 when opening the cover of the cooling box 200. The temperature logger 300 transmits the measurement information containing the temperature data to the user terminal 100 when the cover of the cooling box 200 remains opened. The user terminal 100 is enabled to acquire the internal temperature history of the cooling box 200 with the cover being opened by the user. The user terminal 100 is capable of determining the temperature type of the cooling box 200 from the internal temperature history (the minimum temperatures) of the cooling box 200. The user terminal 100 is capable of determining the internal abnormality (the temperature is beyond the range of the predetermined temperature zone, and other equivalent states) of the cooling box 200.

The temperature control system 10 is enabled to acquire the internal temperature history of the cooling box 200 and to obtain the time when opening the cover of the cooling box 200. The cooling box 200 is opened when the driver of the transport truck or another equivalent vehicle hands over the foods and other equivalent items to the recipient. Therefore, the temperature control system 10 associates the time when handing over the foods and other equivalent items to the recipient with the time when opening the cover of the cooling box 200, and is thereby enabled to acquire the temperature history of the foods and other equivalent items. Hereat, the information indicating which foods and other equivalent items are associated with which cooling box 200 containing these foods and other equivalent items, enables the temperature control system 10 to associate the temperature logger 300 with cooling box that stores this temperature logger 300.

The configurations of the embodiment and other equivalent examples described above may be carried out by being combined to the greatest possible degree.

<Non-Transitory Computer Readable Recording Medium>

A program making a computer, other machines and apparatuses (which will hereinafter be referred to as the computer and other equivalents) attain any one of the functions, can be recorded on a non-transitory recording medium readable by the computer and other equivalents. The computer and other equivalents are made to read and run the program on this non-transitory recording medium, whereby the function thereof can be provided.

Herein, the non-transitory recording medium readable by the computer and other equivalents connotes a non-transitory recording medium capable of accumulating information instanced by data, programs and other equivalents electrically, magnetically, optically, mechanically or by chemical action, which can be read from the computer and other equivalents. In such a non-transitory recording medium, computer building components instanced by the CPU and the memory are provided, and the CPU thereof may be made to run the program.

Among these non-transitory recording mediums, the mediums removable from the computer and other equivalents are exemplified by a flexible disc, a magneto-optic disc, a CD-ROM, a CD-R/W, a DVD, a DAT, an 8 mm tape, and a memory card.

A hard disc, a ROM and other equivalents are given as the non-transitory recording mediums fixed within the computer and other equivalents.

### BRIEF DESCRIPTION OF REFERENCE NUMERALS AND SYMBOLS

10 temperature control system
90 computer
91 processor
92 memory
93 storage unit
94 input unit
95 output unit
96 communication control unit
100 user terminal
110 control unit
120 storage unit
130 communication unit
140 output unit
150 input unit
200 cooling box
200A first cooling box
200B second cooling box
210 bottom surface portion
211 front edge portion
212 right edge portion
213 rear edge portion
214 left edge portion
220 front surface portion
221 lower edge portion
222 right edge portion
223 upper edge portion
224 left edge portion
225 recessed portion
226 groove portion
230 right side surface
231 lower edge portion
232 front edge portion
233 upper edge portion
234 rear edge portion
240 back surface portion
241 lower edge portion
242 right edge portion
243 upper edge portion
244 left edge portion
250 left side surface
251 lower edge portion
252 front edge portion
253 upper edge portion
254 rear edge portion
260 upper surface portion
261 front edge portion
262 right edge portion
263 rear edge portion
264 left edge portion
300 temperature logger
300A first temperature logger
300B second temperature logger
310 body unit
312 control unit
314 storage unit
316 communication unit
318 power unit
320 sensor unit
330 connection cable

1. A temperature control apparatus comprising:
a storage unit storing measurement information containing temperatures measured in a predetermined space and measurement time of the temperature; and
a temperature control unit extracting a minimum temperature defined as a lowest temperature from the temperatures contained in the measurement information, stored in the storage unit, of the predetermined space, and to determine, based on the minimum temperature, a temperature zone to be kept in the predetermined space from within a plurality of temperature zones being different from each other.

2. The temperature control apparatus according to claim 1, wherein the temperature control unit, when a period of time for which the temperature contained in the measurement information is beyond a range of the determined temperature zone is equal to or longer than a predetermined period of time, outputs respectively notification indicating that the period of time of being beyond the range of the temperature zone is equal to or longer than the predetermined period of time.

3. The temperature control apparatus according to claim 1, wherein the temperature control unit, when the minimum temperature is not contained in a predetermined temperature range of the minimum temperatures associated with the plurality of temperature zones, outputs notification indicating that the minimum temperature is not within the predetermined temperature range.

4. The temperature control apparatus according to claim 1, wherein the temperature control unit stores, in the storage unit, an identifier of an apparatus measuring the temperature of the measurement information by being associated with the measurement information and a temperature type to be determined by the temperature control unit.

5. The temperature control apparatus according to claim 1, wherein the predetermined space is a containing space capable of containing an internal object, to be contained, of a container.

6. A temperature control method by which a computer executes:
storing, in a storage unit, measurement information containing temperatures measured in a predetermined space and measurement time of the temperature;
extracting a minimum temperature defined as a lowest temperature from the temperatures contained in the measurement information, stored in the storage unit, of the predetermined space; and
determining, based on the minimum temperature, a temperature zone to be kept in the predetermined space from within a plurality of temperature zones being different from each other.

7. A non-transitory computer readable medium storing a temperature control program for making a computer execute:
storing, in a storage unit, measurement information containing temperatures measured in a predetermined space and measurement time of the temperature;
extracting a minimum temperature defined as a lowest temperature from the temperatures contained in the measurement information, stored in the storage unit, of the predetermined space; and
determining, based on the minimum temperature, a temperature zone to be kept in the predetermined space from within a plurality of temperature zones being different from each other.

8. A temperature control system comprising:
a plurality of containers; and
a temperature control apparatus,
the container including:
a box body having; a containing space formed inside and containable of an object to be contained; and an opening portion enabling the contained object to be contained in and taken out of the containing space;
a cover portion making openable and closable the opening portion; and
a recording device including: a first storage unit storing measurement information containing an internal temperature of the containing space and measurement time of the temperature; and a first communication unit transmitting the measurement information to the temperature control apparatus, the recording device being provided within the cover portion, the box body or the containing space,
outside surfaces of the cover portion and the box body being covered with a metallic material to block communications between the first communication unit and the temperature control apparatus,
the metallic material used blocking of the communication between the first communication unit and the temperature control apparatus being cancelled upon opening the cover portion,
the temperature control apparatus including:
a second communication unit receiving the measurement information from the recording device;
a second storage unit storing the measurement information received by the second communication unit; and
a temperature control unit extracting a minimum temperature defined as a lowest temperature from temperatures contained in the measurement information stored in the second storage unit, and determining, based on the minimum temperature, a temperature zone to be kept in the containing space from within a plurality of temperature zones being different from each other.
